(19) United States
(12) Patent Application Publication
(10) Pub. No.: US 2022/0188721 A1
(43) Pub. Date: Jun. 16, 2022

(54) METHOD AND SYSTEM FOR VALUING THE MOVEMENT AND FLOW OF DATA

(71) Applicant: Mitchell Swan, Richmond, Victoria (AU)

(72) Inventor: Mitchell Swan, Richmond, Victoria (AU)

(21) Appl. No.: 17/420,482

(22) PCT Filed: Dec. 30, 2019
(86) PCT No.: PCT/AU2019/051441

§ 371 Date: Jul. 2, 2021

(30) Foreign Application Priority Data
Jan. 7, 2019 (AU) 2019900043

(51) Int. Cl. G06Q 10/06

(52) U.S. Cl. CPC G06Q 10/0637; G06Q 10/06393

(57) ABSTRACT

Embodiments of the present disclosure provides analytical tools/systems and methods to quantify information flow within an information network having nodes and flow paths between pairs of said nodes. An analytical tool including detecting means configured for detecting the flow paths and map generating means configured for generating a map of the detected flow paths showing relative flow quantities passing along individual paths. The detecting means may include an interface connectable with a node and configured to log data received into and/or sent from the node. The map generating means includes a data processor for reconciling data sent from one node and received by another node to determine a network of internodal data flow paths. The data processor interfaces with an accounting system for tracking costs associated with the network by extracting costs data pertaining to each node from a GL of the accounting system.

### CROSS-REFERENCE TO RELATED APPLICATIONS

The present application is a national stage entry under 35 U.S.C. § 371 of International Application No. PCT/AU2019/051441 filed on Dec. 30, 2019, which claims priority to AU Application No. 2019900043 filed on Jan. 7, 2019, the contents of which are hereby incorporated by reference in their entirety

### TECHNICAL FIELD

The present disclosure is related to the field of determining the value of data movements. More particularly, the present disclosure relates to methods and systems for measuring a value of the data movements and flow of data within different business process nodes in an organisation.

### BACKGROUND

Any references to methods, apparatus or documents of the prior art are not to be taken as constituting any evidence or admission that they formed, or form part of the common general knowledge.

Major data-driven organisations, such as banks, telecommunications providers, energy providers and utilities, tend to lack effective methods for valuing the movement of information from creation to use. Traditional approaches for cost reduction in organisations focus on movement of physical items rather than information.

A significant proportion of operating cost borne by data-driven institutions relates to the creation and movement of data through systems. Currently, banks and telecommunications corporations generally utilise traditional approaches derived from manufacturing approaches in their optimisation efforts. This deals very inadequately with the explosion in information worker roles that now exist. By way of illustration, in a recent public statement of a major financial institution only 40% of their workforce directly interacted with customers.

US patent application publication no. 2013/0151423 attempts to value data as a balance sheet item but does not consider the movement of information between systems and only considers information technology expenditure and direct data “gathering” expenditure rather than attempting to apportion all expenditure directly or indirectly to the information it contributes to.

Previous attempts to value data have focused on valuing data as a financial asset. U.S. Pat. No. 8,690,666B2 describes how data value can be ascertained using a system of wagering when data is stored in multi-tenant database environment. The present disclosure is not concerned with placing a monetary value on the data, but forecasts a value inherent in the data.

No known previous attempt has focused on valuing data movements through the apportionment of business unit and job role operational expenses to the movement of data attributes.

### SUMMARY

It is an object of this present disclosure to address the shortcomings of the prior art and, in doing so, to provide a method, the use of which determines the costs associated with the capture, movement and analysis of data in a data-driven organisation.

In this specification, the term “data-driven organisation” means an organisation in which data transfer internally from one node to another is essential for its operating and functioning.

A further objective of the present disclosure is to provide systems and methods to measure how much movements of data cost in an organisation and where the sum of apportioned costs is highest (or lowest). Further, the present disclosure provides methods and systems for identifying and determining extra cost incurred due to low or poor quality of data and what remediation tasks may be performed for the data quality.

The preceding discussion of the background is intended to facilitate an understanding of the present invention. However, it should be appreciated that the discussion is not an acknowledgement or admission that any of the material referred to was part of the common general knowledge in Australia or elsewhere as at the priority date of the present application.

Further, and unless the context clearly requires otherwise, throughout the description and the claims, the words ‘comprise’, ‘comprising’, and the like are to be construed in an inclusive sense, meaning “including, but not being limited to”—as opposed to an exclusive or exhaustive sense, meaning “including this and nothing else”.

The present disclosure provides a method for defining an organisation by the data it produces and the movement of data into and through nodes associated with its systems. Further, it provides a process of apportioning organisational costs to these data movements. Such units (or nodes) may include (without limitation) sales, onboarding, marketing, provisioning, error handling, customer support, billing, financial crime, general ledger, analytics and the like.

The present disclosure thus provides systems/tools, methods and means for mapping and valuing information movements in an organisation, in addition to or in place of mapping and valuing a process carried on within or by the organisation.

In this specification, “information” or “data” means knowledge transmitted in a tangible form electronically. “Movement” means, in relation to information, the transfer of information from a first location to a second location, the locations being separated by an information transfer conduit. “Operating unit” in the context of an organisation, means a unit that is tasked with performing at least one given function or activity in furtherance of the service delivery aims of the organisation.

The present disclosure provides a system that can be used as a tool by a business consultant or executive in tracing excessive costs in data origination, enrichment and transfer.

According to an aspect of the present disclosure, there is provided an analytical tool or a system operable to quantify information flow within an information network having nodes and flow paths between pairs of said nodes. The analytical tool includes an input module, a detecting means (hereinafter may also be referred as a detecting device); and a map generating means (hereinafter may also be referred as a map generating device). The map generating means are configured for generating a map of the flow paths showing relative flow quantities passing along individual paths. The flow paths may include at least one of one or more flow paths received by the input module and a plurality of flow paths detected by the detecting means.

In some embodiments, the detecting means/device may include software, hardware, firmware or combination of these. In some embodiments, the map generating means/device may include software, hardware, firmware or combination of these. Further the analytical tool or system may include more than two devices or means for performing the one or more steps of the methods disclosed in the present disclosure.

In some embodiments, the detecting means may include an interface connectable with a node and configured to log data received into and/or sent from the node.

In some embodiments, the map generating means may further include: a data processor configured to reconcile data sent from one node and received by another node to determine a network of internodal data flow paths, the data processor interfaces with an accounting system to track costs associated with the network by extracting costs data pertaining to each node from a general ledger of the accounting system, wherein the data processor is configured to determine an aggregate of the costs and apportion the aggregate of the costs among the respective flow paths, wherein a ranking of the flow paths by apportioned cost is ascertainable.

According to another aspect of the present disclosure, there is provided a method of quantifying information flow within an information network including a plurality of nodes and a plurality of flow paths between pairs of said plurality of nodes. In some embodiments, the nodes may include key business process nodes or units. The method includes generating, by a map generating means of an analytical system, a map of the detected flow paths showing relative flow quantities passing along individual paths. The flow paths may include at least one of one or more flow paths received by an input module of the analytical system and a plurality of flow paths detected by a detecting means of the analytical system.

In some embodiments, the method may also include utilising an interface for: connecting the detecting means (or the flow path detecting means) to a node and logging data received into and/or sent from the node; and logging metadata pertaining to said information/data sent or received.

In some embodiments, the method may also include measuring, by a data processor of the map generating means, data quality by at least one of reconciling the information by reconciling data sent from one node of the one or more key business process nodes and received by another node of the one or more key business process nodes to determine a network of internodal data flow paths and performing one or more data quality checks. The non-limiting examples of one or more data quality checks may include data entry errors checks, values outside of expected ranges checks, completeness checks, spelling and grammar check, formatting check, and so forth.

In some embodiments, the method may also include interfacing with an accounting system for tracking one or more costs associated with the network by extracting costs data pertaining to each node from a general ledger of the accounting system. The method in some embodiments also includes determining, by the data processor, an aggregate of the costs and apportion the aggregate of the costs among the respective flow paths, whereby a ranking of the flow paths by apportioned cost is ascertainable.

In other embodiments, the method may include determining, by the data processor, a unit cost of an information unit for a selected flow path. The information unit may include an information record in a database. The method may also include generating an output including a data quality profiling for one or more selected information flow paths.

The present disclosure also provides a system configured to determine what costs are applicable to the movement of data within an organisation. The system is also configured to determine costs lost to quality of the data. Further, the system is configured to be integrated in a finance system to calculate the annual costs in moving the data.

According to another aspect of the present disclosure, there is provided a method of setting a value on data movement within an enterprise network including a plurality of operating nodes. The information flows between the plurality of operating nodes. The method includes developing a cost driver model (hereinafter also referred as an “Apportionment based Costed Data” (ABCD) model) in which individual internodal flows of said information are identified, and implementing the cost driver model with respect to each of said flows, the model requiring apportionment of costs accumulated in operating the nodes between the individually identified flows.

In some embodiments of the present disclosure, the developing the cost driver model includes documenting for each business node the information flows to, from and within it.

In some embodiments of the present disclosure, the method includes identifying an outcome for each flow.

In some embodiments, the method may also include identifying an activity driver for each flow of the identified flows.

In an embodiment of the present disclosure, the method also includes generating a data flow map showing flow volumes between nodes.

In some embodiments, the method further includes determining a cost associated with moving data from a first node to a second.

In some embodiments of the present disclosure, the method includes identifying areas for cost improvement in the organisation.

In some embodiments of the present disclosure, the method includes setting an information cost target and applying analytics to an information channel relating to the target in a manner effective to reach the target.

In some embodiments of the present disclosure, the method includes determining an impact of data quality on network operating cost in a manner to prioritise data cleansing.

In some embodiments of the present disclosure, the method includes taking a lineage-based view of the information flows. Preferably the method includes then applying the following formula to value each flow of information in an organisation:

$$Cost of a Flow = {\sum }_{i = 0}^{n} [ {( \begin{matrix}{Expendiure}_{i} * DQFactor * \\ \frac{UnitsAllocated}{{TotalUnitsForExpenditure}_{i}}\end{matrix} )}_{DQCost} + {( \begin{matrix}{Expendiure}_{i} * ( 1 - DQFactor ) * \\ \frac{UnitsAllocated}{{TotalUnitsForExpenditure}_{i}}\end{matrix} )}_{NonDQCost} ]$$

### Where:

each expenditure “i” of all expenditures “n” is apportioned to the information flow (using the relevant general ledger code or similar identifier as a key)
“Expenditure” is the total value of the expenditure for the period under assessment
“DQFactor” is the percentage of an individual flow under consideration and expenditure that has been caused by poor data quality. This may be provided directly from a known data quality tool or from an estimate provided by a business analyst.
“UnitsAllocated” divided by “TotalUnitsForExpenditure” represents the portion of this expense to be allocated to this information flow.

According to another aspect of the present disclosure, there is provided a method of identifying relative costs of information flows between nodes in a network operated by an organisation. The method may include generating an information flow map in which information flows are mapped between the nodes and discrete information flow components are identified; determining operating costs associated with each node; and apportioning costs of each node between the identified discrete components flowing to or from the node.

In some embodiments, wherein determining the operating costs associated with each node further includes logging information records received at or sent from each node further includes logging information records received at or sent from each node.

The method extends to defining a data heavy organisation by its data outcomes by apportioning overhead costs as data moves through nodes associated with various business units (nodes) of the organisation to individual data flows.

According to another aspect of the present disclosure, there is provided a method for determining a cost for capturing, moving, and analysing data by using an analytical system. The method includes extracting financial data comprising operational expenses (OPEX) from a financial data source comprising a general ledger (GL) that have not already been mapped as a direct expense to at least one of a product or a service. The method also includes mapping a plurality of data flows at a high level with architects and a low level with automated lineage tools by profiling the data to understand volumes and complexity of the data. The method also includes mapping one or more key business process nodes for data capture and reference data for identifying costs from the captured data. The method further includes apportioning identified costs from the one or more key business process nodes to an applicable data flow of the plurality of data flows.

In some embodiments of the present disclosure, the method may further include measuring data quality by at least one of reconciling information by reconciling data sent from one node of the one or more key business process nodes and received by another node of the one or more key business process nodes to determine a network of internodal data flow paths and performing one or more data quality checks. Examples of the data quality checks may include checking data is not null, is within acceptable values/ranges, data entry error checks, and so forth.

According to an embodiment, the method includes mapping the data to the plurality of data flows or data flow paths.

In some embodiments, the method includes tracking one or more costs associated with the network by extracting costs data pertaining to each node from the general ledger of the accounting system or any other financial information system.

In some embodiments of the present disclosure, the method may further include: receiving financial information comprising the extracted OPEX data from the GL (General Ledger) and information from other financial data sources, attribute movement information from metadata systems or other key business process nodes, frequency of attribute movement from schedulers, job role and business unit information from the one or more key business process nodes including such as, but not limited to, enterprise systems, and stakeholder engagement, apportionment of attribute movements to job role and business unit from the one or more key business process nodes; validating and interpreting financial information; validating attribute movements based on at least one of the attribute movement information, and the frequency of attribute movement; attributing job role, business unit or other financial information to each attribute movements of the validated attribute movements based on the received job role and business unit information and the apportionment of attribute movements to job role and business unit from the one or more key business process nodes; reconciling financial information that has been fully attributed onto attribute movements; and preparing information comprising pre-attribute movement values for every attribute movements, reconciliation back to financial system information, and analytical roll up to business unit and job role information for business use.

In some embodiments of the present disclosure, the method also includes reconciling information further comprises reconciling data sent from one node of the one or more key business process nodes and received by another node of the one or more key business process nodes to determine a network of internodal data flow paths; measuring data quality and mapping the data to the plurality of data flows; and tracking one or more costs associated with the network by extracting costs data pertaining to each node from a general ledger of the accounting system.

In some embodiments of the present disclosure, the method also includes receiving financial information comprising the extracted OPEX data from the GL and information from other financial data sources, attribute movement information from metadata systems or other key business process nodes, frequency of attribute movement from schedulers, job role and business unit information from the one or more key business process nodes comprising enterprise systems, and stakeholder engagement, apportionment of attribute movements to job role and business unit from the one or more key business process nodes; validating and interpreting financial information; validating attribute movements based on at least one of the attribute movement information, and the frequency of attribute movement; attributing job role, business unit or other financial information to each attribute movements of the validated attribute movements based on the received job role and business unit information and the apportionment of attribute movements to job role and business unit from the one or more key business process nodes; reconciling financial information that has been fully attributed onto attribute movements; and preparing information comprising pre-attribute movement values for every attribute movements, reconciliation back to financial system information, and analytical roll up to business unit and job role information for business use.

In some embodiments of the present disclosure, the method includes: receiving attribute movement valuations for all movements, record and table schemas, other metadata for attributes, rows, and lineages, and schedule information, from the one or more key business process nodes. The method also includes determining a frequency of record and time period related to the record based on at least one of the record and table schemas, other metadata for attributes, rows, and lineages, and schedule information; identifying immediate movements of attributed that went into the record; and identifying all upstream movements of attributed right back to attribute creation. The method may also include aggregating the attribute movement valuations for the record to determine: per-record level valuations comprising the movements that established the record; and per-record level valuations consisting of all upstream movements that established the record.

In some embodiments of the present disclosure, the method may further include: receiving data including rules what constitutes or defines a valid attribute, measurements against validity rules, attribute, record and lineage schemas, apportionment data for how much of each job role or business unit is affected by quality issues; determining one or more attribute movements of the attribute movements related to the measurement and rules based on the received data; and identifying relevant costs associated with the determined one or more attribute movements. The method may also include apportioning the business costs that are caused by quality issue to determine: per-attribute and per-record valuations of all movement valuations that can be apportioned to quality; and per-quality rule valuations of the attribute movements that contributed to the rule and failure of the rule.

In some embodiments, the data including the rules what constitutes or defines a valid attribute, measurements against validity rules, attribute, record and lineage schemas, apportionment data for how much of each job role or business unit is affected by quality issues may be received by using surveys and stakeholder analysis from the one or more key business process nodes.

In some embodiments of the present disclosure, the method may further include: identifying expensive areas and processes to target; and for the identified processes: prioritising work by business process management teams for expensive captured processes; restructuring underperforming information areas; identifying expensive decision-making process and developing decision models; identifying opportunities to utilise automation tools.

in some embodiments, the method includes enhancing data quality of captured data. In a non-limiting example, the data quality may be enhanced by actioning a plan to cleanse poor-quality data and actioning a plan to remediate root causes for the poor-quality data. The method may also include changing the captured processed to enhance the data quality; and measuring and monitoring an impact.

According to another aspect of the present disclosure, there is provided an analytical system for determining a cost for capturing, moving, and analysing data. The analytical system is configured for extracting financial data comprising operational expenses (OPEX) from a financial data source comprising a general ledger (GL) that have not already been mapped as a direct expense to at least one of a product or a service; mapping a plurality of data flows at a high level with architects and a low level with automated lineage tools by profiling the data to understand volumes and complexity of the data; mapping one or more key business process nodes for data capture and reference data for identifying costs from the captured data; and apportioning identified costs from the one or more key business process nodes to an applicable data flow of the plurality of data flows.

In some embodiments, the analytical system is also configured for data quality apportionment by: identifying expenses and data most affected by data quality; determining and taking a cleanse or remediation action; and measuring and monitoring an impact of the cleanse or remediation action.

Another embodiment of the present disclosure also provides a non-transitory computer readable storage medium determining a cost for capturing, moving, and analysing data, when executed by a computing device cause the computing device to: extract financial data comprising operational expenses (OPEX) from a financial data source comprising a general ledger (GL) that have not already been mapped as a direct expense to at least one of a product or a service; map a plurality of data flows at a high level with architects and at a low level with automated lineage tools by profiling the data to understand volumes and complexity of the data; map one or more key business process nodes for data capture and reference data for identifying costs from the captured data; and apportion identified costs from the one or more key business process nodes to an applicable data flow of the plurality of data flows.

### BRIEF DESCRIPTION OF DRAWINGS

In order that the present disclosure may be readily understood, and put into practical effect, reference will now be made to the accompanying figures. Thus:

FIG. 1 shows in schematic form a diagram of a preferred embodiment of the operating environment of this present disclosure; and

FIG. 2 is a flowchart diagram illustrating a method for determining a cost for capturing, moving and analysing data, in accordance with an embodiment of the present disclosure.

### DETAILED DESCRIPTION

The present disclosure provides systems and methods for information management by identifying the value of information moving through an organisation and addressing a source thereof.

Prior to discussing the details of the present disclosure, it should be understood that several sections of the following description are presented largely in terms of logic and operations that may be performed by conventional components. These components, which may be grouped in a single location or distributed over a wide area, generally include processors, memory, storage devices, graphical displays, input devices, etc. In circumstances where the components are distributed, the components are accessible to each other via communication links/interfaces. In the following description, numerous specific details are set forth in order to provide a description of the present disclosure. It will be apparent to one skilled in the art, however, that the disclosed subject matter may be practiced without some or all of the specific details.

Referring now to the drawing, wherein like reference numbers are used herein to designate like elements throughout, views and embodiments of the process of the present disclosure are illustrated and described, and other possible embodiments are described. The figures are simplified in places for illustrative purposes only. One of ordinary skill in the art will appreciate the many possible applications and variations based on the following examples of possible embodiments.

The present disclosure is suitable for use in service-providing organisations and will be described in this context in the embodiment(s) to follow. However, the concept may also be applied to organisations providing a product offering in the form of merchandise, or a range that includes both goods and services.

The method comprises at least one of receiving, by an input module of an analysis system, information flows in an organisation under scrutiny by business unit thereof, referred to herein as a node, documenting for each business unit (or node) an information flow, an outcome for the flow and an activity driver for the flow. In some embodiments, the information flows in the organisation are automatically detected by a detecting means of the In particular, in the method of the present disclosure, a sum representing operating expenses (OPEX) of the organisation, that have not already been mapped as a direct expenses to a product or service, is extracted from the organisation's general ledger (GL) by means of network and system interfaces accessible by the valuing platform. Other financial information may also be extracted as necessary, including information pertaining to the individual node, such as job roles defined for personnel associated with it.

The platform accesses metadata systems for metadata relating to the various information flows identified and documented. Information flows are mapped and profiled to obtain volume characteristics and identify complexities in specific flows or in the data contained in the information itself. Mapping may be performed using automated lineage tools. The data extracted from the general ledger is processed by a financial statement interpreter tool.

From the flow mapping, key business processes associated with data capture and data reference are mapped. The OPEX sum extracted from the general ledger is then apportioned to the identified individual flows. Apportionment may be by way of applying a percentage of the cost on the basis of data record numbers, or by taking into account an additional or alternative factor, such as data quality. A map is generated to show each flow and the apportioned value associated with it.

As an optional step, the quality of the data in each flow or in a selection of flows, such as the flows associated with the key business processes, is mapped and measured for a data quality profiling output to be generated.

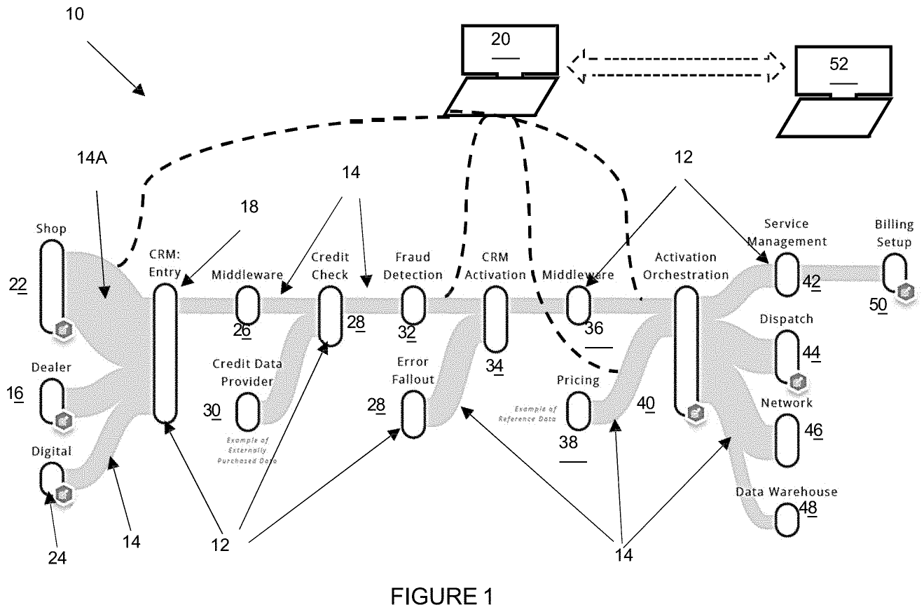

Referring to FIG. 1, the implementation of this present disclosure in a preferred embodiment is illustrated in an organisation generally denoted by the number 10. The organisation 10 may include a plurality of functional nodes 12 indicated by various oval shapes, denoting functions such as a retail shopfront (shop) 22, an on-seller or dealer 16 in the organisation's product offerings, a credit data provider 30, a service management unit 42, a fraud detection unit 32, a data warehouse, and a product dispatch unit 44. Not all nodes are specifically pointed out by pointer arrows.

Within the organisation, and connecting pairs and groups of the nodes, are data flow conduits operatively configured to enable a near-constant flow of data along information flow channels 14, Again, pointer arrows do not point out every last one of these, for avoiding drawing congestion and for reader convenience. High capacity data flow conduits are represented by thicker flow channels, such as conduit 14A.

In this embodiment, the platform of the present disclosure is configured and programmed through an associated computer processor 20 to monitor data flow in the respective channels 14 of the organisation's data bus. Monitoring is represented by exemplary curved dashed lines emanating from the processor. Data flow is measured in units of data records, each record comprising a number of fields populated or unpopulated. The processor performs comparisons of data volumes and compiles and outputs reports identifying the most ‘data fat’ channels, an example in FIG. 1 being channel 14A.

The channels are non-directional in the sense that data flows may occur in either or in both directions, for example from a dealer node 16 to and from customer registration node 18. The processor is programmed for data output reports to cover pre-set time periods, for example at peak sales times, or over months or seasonal periods, and to be communicated at relatively data lean periods, for example after office hours.

The platform processor may be in data communication with the sales nodes of the organisation 10, a shopfront 22, a dealer 16, and an online store 24. Data flowing out of the sales nodes is collected for processing and storage at a customer registration node (CRM) 18. Typically, the data includes revenue data from sales, associated expense data, customer data from new customers being subscribed to product or service systems offered by the platform operator, staff-related data and management data.

The processor 20 traces data flow from the customer registration node 18 to a middleware node 26 and on to a credit check node 28, which is linked via an application program interface (API) to data available at a price from an external credit rating agency 30. The credit check node is programmed to run an algorithm to test and decide, on the basis of a report procured from an agency 30, whether a prospective customer is to be allowed credit, for example in respect of an account to be billed in arrears for services rendered, as it conventional in the art of credit control, Should credit check node 28 determine on criteria applied to the prospective customer that the customer passes the threshold for credit in the form of an arrears billed account, the relevant customer data, such as name, contact details, banking and identification details, are transferred with a query to the fraud detection node/unit 32, to investigate whether the customer has any known or ascertainable links with fraudulent activity. The activity carried out by the fraud detection node 32 may include the use of an API to check criminal records available from law enforcement authorities, court records or other government agencies or private data suppliers, whether the prospective customer meets criteria that have been pre-set to bar their acceptance as a credit customer. Processor 20 collects logs of all the above-mentioned data flows. In some embodiments, the data flow paths (or data flows) may include one or more flow paths received as an input by an input module of the analytical tool 10 (or system 10). In alternative embodiments, the data flow paths may include a a plurality of flow paths detected by a detecting means of the analytical tool 10.

Depending on the output of the fraud detection node 32, the customer registration may be activated at an activation node 34. A data record confirming activation is transmitted to a middleware node 36 to an activation orchestration node 38, which is in data communication with a pricing node 40, from which pricing data for the product offerings of the organisation is obtained.

The activation orchestration node 40 is also in bi-directional multiplexed data communication with downstream nodes for service management 42, goods dispatch 44, a communications network 46, and a data warehouse 48. These nodes (may also be referred as units) are mentioned by way of non-limiting example for explaining the data-driven context of operation of the present disclosure in this preferred embodiment.

The service management node 42 is further connected to a billing set-up node 50, the function of the billing set-up node 50 is to receive new customer details and enter them into records for enabling bills to be dispatched to the customer at agreed intervals or by other arrangement. The dispatch function 44 may also involves costs. When billing requirements have been successfully set up, the billing set-up node 50 can confirm this to the service management node 42 and this information may be fed back to the orchestration node 42, so that the customer's service on the network may be activated by the network node 46. Customer details may also be sent to the data warehouse for logging of all customer activity in use of the customer's handset on the network. The dispatch node 44 may return confirmation of dispatch of the customer's handset and its details such as serial number, make and model number and the like.

In some embodiments, the analytical tool or the system of the present disclosure collects information about the data flows to and from the nodes and reconciles information that has left a first node with the information received by a second node to which the information is sent. From running a network construction algorithm, the processor of the tool constructs a map of the network of the nodes and the information flows between respective pair of them. Certain nodes, such as the orchestration node 42, are shown to receive and send data from and to more than one node. The algorithm causes the analytical tool to collect metadata concerning the flow paths from which data traffic volume is determined between node pairs.

The processor 20 also communicates through established methods with an accounting system computer 52 issuing a request for costs data from the general ledger in the accounting system of the organisation being analysed. The general ledger (CL) may reveal cost information pertaining to each node of the network. The processor 20 retrieves the required costs information and by dividing the data flow volume to and from each node by the cost of operating the node, is able to output a value attaching to the flow path concerned and to each unit of information or data moving along it.

The following is a representative formula that can be applied for each information flow:

$$Cost of a Flow = {\sum }_{i = 0}^{n} [ {( \begin{matrix}{Expendiure}_{i} * DQFactor * \\ \frac{UnitsAllocated}{{TotalUnitsForExpenditure}_{i}}\end{matrix} )}_{DQCost} + {( \begin{matrix}{Expendiure}_{i} * ( 1 - DQFactor ) * \\ \frac{UnitsAllocated}{{TotalUnitsForExpenditure}_{i}}\end{matrix} )}_{NonDQCost} ]$$

Where:

Each expenditure “i” of all expenditures “n” is apportioned to the information flow (using the relevant general ledger code or similar as a key)

“Expenditure” is the total value of the expenditure for the period under assessment

“DQFactor” is the percentage of an individual flow under consideration and expenditure that has been caused by poor data quality. This can be provided or obtained directly from a known data quality tool or an estimate provided by a business analyst.

“UnitsAllocated” divided by “TotalUnitsForExpenditure” represents the portion of this expense to be allocated to this information flow.

The OPEX aggregate is then apportioned to the data flow path or paths leaving each node, providing an indication of the cost of data handling by the node in question.

The implementation of the present disclosure according to an embodiment of the present disclosure will now be described, using the example following.

### EXAMPLE

Communications service provider ABComco has commenced offering a new service to customers. Behind the scenes, the activities required for bringing the customer on board to receive the new service are very complex and therefore prone to errors and failures. The entirely of processes that are carried out to “on board” a customer are collectively termed “order to activate”. The data flow map of FIG. 1 will be referred to in the following paragraphs.

Suppose a new customer K Custo walks into the retail outlet 22 (see FIG. 1) operated by ABComco, intending to purchase a new mobile telephone handset. The data points that represent the interaction that follows between ABComco and K Custo are examined. The various ways in which K Custo may come into ABComco are termed “channels” and each one is associated with a monetary cost to operate. Generally, it would cost ABComco less to sign the customer up with the online store 24 than by interaction in the physical retail outlet 22 or via the dealer 16. In the latter case a client care agent in the store will obtain all the necessary customer data and enter it into a web form generated and processed by ABComco's data capture application. The data captured is then sent downstream.

In this example, it costs ABComco $2 m per annum to operate the retail outlet 22. At the outlet, various activities are performed, including those that result in the customer data being captured. The annual expenditure therefore includes data pertaining to new customers, disconnected customers and support tickets for all products in the range offered by ABComco, These include broadband connectivity services as well as mobile telephony. ABComco has an algorithm that apportions the costs it incurs to the benefit of the data generated. The running of the algorithm determines that to produce a data record for customer K Custo cost $40. The following table is illustrative:

### K Custo Record

| | | | | | APP |
|---|---|---|---|---|---|
| | | | | | ORTIONED |
| | [symbol] | [symbol] | [symbol] | [symbol] | RECORD |
| [symbol] | AME | HONE | ADDRESS | RODUCT | COST |
| [symbol] | [symbol] | 400 | 3 | [symbol] | ~$40 |
| | Custo | 000 | Example St | DSL | |
| | | 000 | | | |
| AP | [symbol] | $10 | ~ [symbol] | [symbol] | [symbol] |
| PORTIONED | $10 | | $10 | $10 | |
| FIELD COST | | | | | |

[symbol]

indicates data missing or illegible when filed

In the process of signing up a customer, a credit worthiness evaluation is carried out at the node 28, as is a check for records of fraudulent activity involving the customer may be done by the fraud detection node 32.

In this example, it costs $5 million to run ABComco's Credit Department 28, $3 million of which is the data they buy from a third-party credit record supply operation. After apportionment, the purchase of data cost $2 and the work cost $3:

### K Custo Record

| | | | | | | [symbol] |
|---|---|---|---|---|---|---|
| | | | | | | APPOR- |
| | | | | | [symbol] | TIONED |
| | [symbol] | [symbol] | [symbol] | [symbol] | REDIT | RECORD |
| [symbol] | AME | HONE | ADDRESS | RODUCT | CHECK | COST |
| [symbol] | [symbol] | [symbol] | [symbol] 3 | [symbol] | [symbol] | [symbol] |
| | Custo | 400 000 | Example | DSL | assed | ~$40 + |
| | | 000 | St | | | $2 + $3 |
| [symbol] | [symbol] | [symbol] | [symbol] | [symbol] | [symbol] | [symbol] |
| APPOR- | $10 | $10 | ~$10 | $10 | $2 + $3 | |
| TIONED | | | | | | |
| FIELD COST | | | | | | |

[symbol]

indicates data missing or illegible when filed

Following a satisfactory outcome from the credit check carried out on prospective new customer K Custo, a billing account is set up using the separate computerised billing setup node 50, operated by a different team of personnel from the team operating the data capture system. Setting up the billing account for the customer costs $10.

### K Custo Record

| | | | | | | | [symbol] |
|---|---|---|---|---|---|---|---|
| | | | | | [symbol] | [symbol] | APPORTIONED |
| | [symbol] | [symbol] | [symbol] | [symbol] | CREDIT | BILLING | RECORD |
| [symbol] | NAME | PHONE | ADDRESS | PRODUCT | CHECK | ACCOUNT | COST |
| [symbol] | [symbol] | [symbol] | [symbol] | [symbol] | [symbol] | [symbol] | [symbol] |
| | Custo | 400 000 | Example | DSL | assed | 23456 | ~$40 + $2 + |
| | | 000 | St | | | | $3 + $10 |
| [symbol] | [symbol] | [symbol] | [symbol] | [symbol] | [symbol] | [symbol] | [symbol] |
| APPOR- | $10 | $10 | $10 | $10 | $2 + $3 | $10 | |
| TIONED | | | | | | | |
| FIELD | | | | | | | |
| COST | | | | | | | |

[symbol]

indicates data missing or illegible when filed

The client service agent in the store made a data entry error in entering the telephone number of the customer. This causes a failure in the setting up of the billing account for K Custo. The service provider, ABComco labels this internally as “Error Provisioning”, which means the entire order placed by K Custo needs to be fixed and resubmitted. This incurs additional costs and the activities are attended to by a different team of personnel such as the service management 42, hitherto not involved in the signing up of this customer. Suppose that the added cost after detection, investigation and resolution of the input error came to $60. This amount is attributable to the K Custo record.

### K Custo Record

| | | | | | [symbol] | [symbol] | [symbol] | [symbol] |
|---|---|---|---|---|---|---|---|---|
| | [symbol] | [symbol] | [symbol] | [symbol] | CREDIT | BILLING | APPORTIONED | APPORTIONED |
| [symbol] | NAME | PHONE | ADDRESS | PRODUCT | CHECK | ACCOUNT | RECORD COST | QUALITY COST |
| [symbol] | [symbol] | [symbol] | [symbol] | [symbol] | [symbol] | [symbol] | [symbol] | [symbol] |
| | Custo | 400 123 | Example | DSL | assed | 23456 | $40 + | $60 |
| | | 456 | St | | | | $2 + | |
| | | | | | | | $3 + $10 | |
| [symbol] | [symbol] | [symbol] | [symbol] | [symbol] | [symbol] | [symbol] | [symbol] | [symbol] |
| PPOR- | $10 | $10 | $10 | $10 | $2 + $3 | $10 | | |
| TIONED | | | | | | | | |
| FIELD | | | | | | | | |
| COST | | | | | | | | |
| [symbol] | [symbol] | [symbol] | [symbol] | [symbol] | [symbol] | [symbol] | [symbol] | [symbol] |
| PPOR- | | $60 | | | | | | |
| TIONED | | | | | | | | |
| QUALITY | | | | | | | | |
| COST | | | | | | | | |

[symbol]

indicates data missing or illegible when filed

The dispatch function 44 may also involves costs. Sending out a handset to the address of the customer K Custo, who was not able to take the phone purchased with him when he left the retail outlet, because of stock unavailability, also produces further data. ABComco outsources its dispatch functions to a separate entity, going by the name of Coolstar. The dispatch fee charged by Coolstar is $7.

### K Custo Record

| | | | | | [symbol] | [symbol] | [symbol] | | |
|---|---|---|---|---|---|---|---|---|---|
| | [symbol] | [symbol] | [symbol] | [symbol] | CREDIT | BILLING | DISPATCH | [symbol] | [symbol] |
| [symbol] | NAME | PHONE | ADDRESS | PRO | CHECK | ACCOUNT | DATE | APPORTIONED | APPORTIONED |
| [symbol] | [symbol] | [symbol] | [symbol] | [symbol] | [symbol] | [symbol] | [symbol] | [symbol] | [symbol] |
| | Custo | 400 123 | Example | DSL | assed | 23456 | 2 Oct. | $40 + | $60 |
| | | 456 | St | | | | 2018 | $2 + $3 + | |
| | | | | | | | | $10 + $7 | |
| [symbol] | [symbol] | [symbol] | [symbol] | [symbol] | [symbol] | [symbol] | [symbol] | [symbol] | [symbol] |
| PPORTIONED | $10 | $10 | $10 | $10 | $2 + $3 | $10 | $7 | | |
| FIELD | | | | | | | | | |
| COST | | | | | | | | | |
| [symbol] | [symbol] | [symbol] | [symbol] | [symbol] | [symbol] | [symbol] | [symbol] | [symbol] | [symbol] |
| PPORTIONED | | $60 | | | | | | | |
| QUALITY | | | | | | | | | |
| COST | | | | | | | | | |

[symbol]

indicates data missing or illegible when filed

In addition to the above activities, human input is required for setting up 46 K Custo's new handset to operate on and with the service provider's network. Where two or more networks are being operated by the provider, the handset needs to be configured to run on both. There are additional services requiring set up, including voicemail, call forwarding, private numbers, and the like. The cost of set up is $6.

### K Custo Record

| | | | | | | | | | | [symbol] | |
|---|---|---|---|---|---|---|---|---|---|---|---|
| | | | | | | | [symbol] | | | APPOR- | |
| | | | | | | | DIS- | [symbol] | [symbol] | TIONED | |
| | [symbol] | [symbol] | [symbol] | [symbol] | [symbol] | [symbol] | PATCH | Voice- | 4G | RECORD | [symbol] |
| [symbol] | NAME | PHONE | ADDRESS | PRODUCT | CREDIT | BILLING | DATE | mail | IMEI | COST | APPORTIO |
| [symbol] | [symbol] | [symbol] | [symbol] | [symbol] | [symbol] | [symbol] | [symbol] | [symbol] | [symbol] | [symbol] | [symbol] |
| | K Custo | 400 | Example | ADSL | Passed | 23456 | 2 Oct. | es | 23456 | $40 + $2 + | $60 |
| | | 123 | St | | | | 2018 | | | $3 + $10 + | |
| | | 456 | | | | | | | | $7 | |
| [symbol] | [symbol] | [symbol] | [symbol] | [symbol] | [symbol] | [symbol] | [symbol] | [symbol] | [symbol] | [symbol] | [symbol] |
| PPOR- | $10 | $10 | $10 | $10 | $2 + $3 | $10 | $7 | $3 | $3 | | |
| TIONED | | | | | | | | | | | |
| FIELD | | | | | | | | | | | |
| COST | | | | | | | | | | | |
| [symbol] | [symbol] | [symbol] | [symbol] | [symbol] | [symbol] | [symbol] | [symbol] | [symbol] | [symbol] | [symbol] | [symbol] |
| PPOR- | | $60 | | | | | | | | | |
| TIONED | | | | | | | | | | | |
| QUALITY | | | | | | | | | | | |
| COST | | | | | | | | | | | |

[symbol]

indicates data missing or illegible when filed

From the above is can be seen that the simple process of signing up a new customer needs extrapolation to every business unit of a service provider and to every piece of data that the organisation generates or captures. Furthermore, the data flows need to link back to the organisation's general ledger of its accounting system. The total cost of all such data reports to the “operating expense” line.

The tool of the present disclosure accesses the data flow paths and determines relative data volumes, content, metadata and data quality metrics from relevant information technology (IT) systems. It also accesses the accounting system to extract relevant financial information that relates to the flow of data between nodes. It also maintains a repository of unitised apportionments for each expenditure to each information flow. From this, the cost of each information flow can be determined by apportionment of general ledger expenses and split into data quality and non-data quality components. This leads to identifying where the costliest data originates for the organisation, enabling human input to remedy unproductive or inefficient conditions and structures.

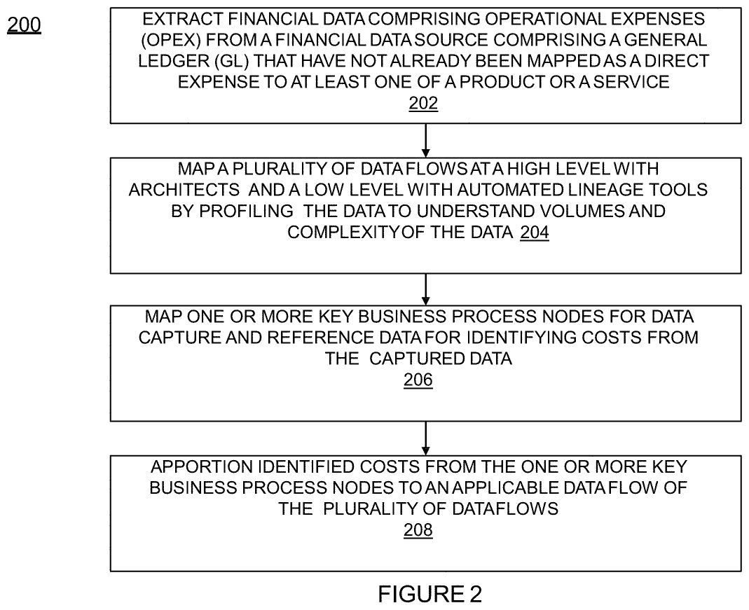

Referring now to the FIG. 2, a flowchart diagram illustrating a method 200 for determining a cost for capturing, moving and analysing data, in accordance with an embodiment of the present disclosure. The method 200 is an apportionment based costed data (ABCD) method that can be used to determine how much it costs to capture, move and analyse data in an organisation. One or more steps of the method 200 may be implemented on one or more modules or devices of an analytical system of the present disclosure.

At step 202, financial data/information comprising operational expenses (OPEX) are extracted from a financial data/information source comprising a general ledger (GL) and stakeholder engagement and the like that have not already been mapped as a direct expense to at least one of a product or a service. In some embodiments, a financial statement interpreter of the analytical system may extract, validate and interpret the financial information.

At step 204, a plurality of data flows are mapped at a high level with architects and at a low level with automated lineage tools by profiling the data to understand volumes and complexity of the data. In some embodiments, the data flows are received as an input by an input module of the analysis system. In alternative embodiments, the data flows may be detected (automatically) by a detecting means or device of the analysis system. In some embodiments, an attribute content analyser of the analytical system may validate attribute (data) movements based on attribute movement information from metadata systems or otherwise and frequency of attribute movement from schedulers or otherwise. Further, an attribute content analyser of the analytical system may attribute job role, business unit or other financial information to each attribute movement and reconcile the financial data/information that has been fully attributed onto attribute movements, The job role, and business unit information may be extracted or captured from enterprise systems, stakeholder engagement or other systems in an organisation. Further, the attribute content analyser may determine per-attribute-movement values for every attribute movement.

Then at step 206, one or more key business process nodes are mapped for data capture and reference data for identifying costs from the captured data. In some embodiments, an audit/reconciliation module of the analytical system may reconcile the financial data/information that has been fully attributed into the attribute movements. Further, the audit/reconciliation module may reconcile back to financial system information.

In some embodiments, costs for the one or more key business process nodes (node i to node n) may be calculated using the following formula:

$${\sum }_{i = 0}^{n} {DirectCost}_{i} + {DQCost}_{i} + ( {IndirectCost}_{i} * WeightingFactor )$$

### Where:

DirectCostᵢ: Direct costs incurred by data of a business process node I;

DQCostᵢ: Data Quality cost at the business process node i

IndirectCostᵢ: Indirect costs incurred by data in the business process node i

WeightingFactor: weight given to a data point or node

In some embodiments, based on rules for what constitutes a valid attribute and measurements against validity rules, the analytical system may determine which attribute movements the measurement and rules belongs to. Further, the system may identify relevant costs associated with those movements. In some embodiments, the analytical system may measure data quality and map to the method 200 (or the ABCD method) by apportioning the business costs that were caused by the quality issue. In some embodiments, a data processor of the map generating means may measure the data quality. The data quality may be measured by reconciling information by reconciling data sent from one node of the one or more key business process nodes and received by another node of the one or more key business process nodes to determine a network of internodal data flow paths. Further, the data quality may be measured by performing one or more data quality checks. The non-limiting examples of one or more data quality checks may include data entry errors checks, values outside of expected ranges checks, completeness checks, spelling and grammar check, formatting check, and so forth. Further, the analytical system may determine per-attribute and per-record valuations of all movement valuations that can be apportioned to quality. Further, the analytical system may determine per-quality rule valuations of the attribute movements that contributed to the rule and failure of the rule.

Thereafter, at step 208, the identified costs from the one or more key business process nodes are apportioned to an applicable data flow of the plurality of data flows. In some embodiments, an apportionment module of the analytical system may apportion the attribute movements to job role and business unit (i.e. one or more key business process nodes). A reporting module may prepare information for business use.

According to an embodiment of the present disclosure, there is provided a method for determining a cost for capturing, moving, and analysing data by using an analytical system. The method includes extracting financial data comprising operational expenses (OPEX) from a financial data source such as, but not limited to, a general ledger (GL) that have not already been mapped as a direct expense to at least one of a product or a service. The method also includes mapping a plurality of data flows at a high level with architects and at a low level with automated lineage tools by profiling the data to understand volumes and complexity of the data. The method also includes mapping one or more key business process nodes for data capture and reference data. The method further includes apportioning identified costs from the captured data from the one or more key business process nodes to an applicable data flow of the plurality of data flows.

According to an aspect of the present disclosure, the method may further include: reconciling information by reconciling data sent from one node of the one or more key business process nodes and received by another node of the one or more key business process nodes to determine a network of internodal data flow paths; measuring data quality and mapping the data to the plurality of data flows; and tracking one or more costs associated with the network by extracting costs data pertaining to each node from a general ledger of the accounting system.

According to another aspect of the present disclosure, the method may further include: receiving or capturing financial information comprising the extracted OPEX data from the GL and information from other financial data sources, attribute movement information from metadata systems or other key business process nodes, frequency of attribute movement from schedulers, job role and business unit (or one or more key business process nodes) information from the one or more key business process nodes including such as, but not limited to, enterprise systems, and stakeholder engagement, apportionment of attribute movements to job role and business unit from the one or more key business process nodes; validating and interpreting financial information; validating attribute movements based on at least one of the attribute movement information, and the frequency of attribute movement; attributing job role, business unit (or one or more key business process nodes) or other financial information to each attribute movements of the validated attribute movements based on the received job role and business unit information and the apportionment of attribute movements to job role and business unit from the one or more key business process nodes; reconciling financial information that has been fully attributed onto attribute movements; and preparing information comprising pre-attribute movement values for every attribute movements, reconciliation back to financial system information, and analytical roll up to business unit and job role information for business use.

According to another aspect of the present disclosure, the method includes: reconciling information further comprises reconciling data sent from one node of the one or more key business process nodes and received by another node of the one or more key business process nodes to determine a network of internodal data flow paths.

In some embodiments, the method may include measuring data quality and mapping the data to the plurality of data flows; and tracking one or more costs associated with the network by extracting costs data pertaining to each node from a general ledger of the accounting system. The data quality may be measured by reconciling information by reconciling data sent from one node of the one or more key business process nodes and received by another node of the one or more key business process nodes to determine a network of internodal data flow paths and performing one or more data quality checks. Examples of the data quality checks may include checking data is not null, is within acceptable values/ranges, data entry error checks, and so forth.

According to another aspect of the present disclosure, the method includes: receiving financial information comprising the extracted OPEX data from the GL and information from other financial data sources, attribute movement information from metadata systems or other key business process nodes, frequency of attribute movement from schedulers, job role and business unit information from the one or more key business process nodes comprising enterprise systems, and stakeholder engagement, apportionment of attribute movements to job role and business unit from the one or more key business process nodes; validating and interpreting financial information; validating attribute movements based on at least one of the attribute movement information, and the frequency of attribute movement; attributing job role, business unit or other financial information to each attribute movements of the validated attribute movements based on the received job role and business unit information and the apportionment of attribute movements to job role and business unit from the one or more key business process nodes; reconciling financial information that has been fully attributed onto attribute movements; and preparing information comprising pre-attribute movement values for every attribute movements, reconciliation back to financial system information, and analytical roll up to business unit/business key process node and job role information for business use.

According to another aspect of the present disclosure, the method includes: receiving attribute movement valuations for all movements, record and table schemas, other metadata for attributes, rows, and lineages, and schedule information, from the one or more key business process nodes; determining a frequency of record and time period related to the record based on at least one of the record and table schemas, other metadata for attributes, rows, and lineages, and schedule information; identifying immediate movements of attributed that went into the record; and identifying all upstream movements of attributed right back to attribute creation. The method may also include aggregating the attribute movement valuations for the record to determine: per-record level valuations comprising the movements that established the record; and per-record level valuations consisting of all upstream movements that established the record.

According to another aspect of the present disclosure, the method may further include: receiving data comprising rules for what constitutes a valid attribute, measurements against validity rules, attribute, record and lineage schemas, apportionment data for how much of each job role or business unit is affected by quality issues; determining one or more attribute movements of the attribute movements related to the measurement and rules based on the received data; and identifying relevant costs associated with the determined one or more attribute movements. The method may also include apportioning the business costs that are caused by quality issue to determine: per-attribute and per-record valuations of all movement valuations that can be apportioned to quality; and per-quality rule valuations of the attribute movements that contributed to the rule and failure of the rule.

In some embodiments, the rules for what constitutes a valid attribute, measurements against validity rules, attribute, record and lineage schemas, apportionment data for how much of each job role or business unit is affected by quality issues may be determined or received by using at least one of surveys and stakeholder analysis from the one or more key business process nodes.

Hereinafter, the terms business unit and key business process node may be used interchangeably without change its meaning.

According to another aspect of the present disclosure, the method may further include: identifying expensive areas and processes to target; and for the identified processes: prioritising work by business process management teams for expensive captured processes; restructuring underperforming information areas; identifying expensive decision-making process and developing decision models; identifying opportunities to utilise automation tools.

Further, the method may include enhancing data quality of captured data, In an example, the data quality may be enhanced by actioning a plan to cleanse poor-quality data; and actioning a plan to remediate root causes for the poor-quality data. The method may also include: changing the captured processed to enhance the data quality; and measuring and monitoring an impact.

According to another embodiment of the present disclosure, there is provided an analytical system for determining a cost for capturing, moving, and analysing data. The analytical system is configured for extracting operational expenses (OPEX) from a general ledger (GL) that have not already been mapped as a direct expense to at least one of a product or a service; mapping a plurality of data flows at a high level with architects and a low level with automated lineage tools by profiling the data to understand volumes and complexity of the data; mapping one or more key business process nodes for data capture and reference data; and apportioning identified costs from the captured data from the one or more key business process nodes to an applicable data flow of the plurality of data flows.

The analytical system may also be configured for: reconciling information by reconciling data sent from one node of the one or more key business process nodes and received by another node of the one or more key business process nodes to determine a network of internodal data flow paths; measuring data quality and mapping the data to the plurality of data flows; and tracking one or more costs associated with the network by extracting costs data pertaining to each node from a general ledger of the accounting system.

The analytical system may also be configured for: receiving financial information comprising the extracted OPEX data from the GL and information from other financial data sources, attribute movement information from metadata systems or other key business process nodes, frequency of attribute movement from schedulers, job role and business unit information from the one or more key business process nodes including such as, but not limited to, enterprise systems, and stakeholder engagement, apportionment of attribute movements to job role and business unit from the one or more key business process nodes; validating and interpreting financial information; validating attribute movements based on at least one of the attribute movement information, and the frequency of attribute movement; attributing job role, business unit or other financial information to each attribute movements of the validated attribute movements based on the received job role and business unit information and the apportionment of attribute movements to job role and business unit from the one or more key business process nodes; reconciling financial information that has been fully attributed onto attribute movements; and preparing information comprising pre-attribute movement values for every attribute movements, reconciliation back to financial system information, and analytical roll up to business unit and job role information for business use.

In some embodiments, the analytical system may also be configured for: reconciling information further comprises measuring data quality by at least one of reconciling information by reconciling data sent from one node of the one or more key business process nodes and received by another node of the one or more key business process nodes to determine a network of internodal data flow paths and performing one or more data quality checks. Examples of the data quality checks may include checking data is not null, is within acceptable values/ranges, data entry error checks, and so forth.

In some embodiments, the analytical system is configured to map the data to the plurality of data flows; and tracking one or more costs associated with the network by extracting costs data pertaining to each node from a general ledger of the accounting system.

In further embodiments, the analytical system may also be configured for: receiving financial information comprising the extracted OPEX data from the GL and information from other financial data sources, attribute movement information from metadata systems or other key business process nodes, frequency of attribute movement from schedulers, job role and business unit information from the one or more key business process nodes comprising enterprise systems, and stakeholder engagement, apportionment of attribute movements to job role and business unit from the one or more key business process nodes; validating and interpreting financial information; validating attribute movements based on at least one of the attribute movement information, and the frequency of attribute movement; attributing job role, business unit or other financial information to each attribute movements of the validated attribute movements based on the received job role and business unit information and the apportionment of attribute movements to job role and business unit from the one or more key business process nodes; reconciling financial information that has been fully attributed onto attribute movements; and preparing information comprising pre-attribute movement values for every attribute movements, reconciliation back to financial system information, and analytical roll up to business unit and job role information for business use.

In alternative embodiments, the analytical system may also be configured for: receiving attribute movement valuations for all movements, record and table schemas, other metadata for attributes, rows, and lineages, and schedule information, from the one or more key business process nodes; determining a frequency of record and time period related to the record based on at least one of the record and table schemas; other metadata for attributes, rows, and lineages, and schedule information; identifying immediate movements of attributed that went into the record; and identifying all upstream movements of attributed right back to attribute creation. The method may also include aggregating the attribute movement valuations for the record to determine: per-record level valuations comprising the movements that established the record; and per-record level valuations consisting of all upstream movements that established the record.

In some embodiments, the analytical system may also be configured for: receiving data comprising rules for what constitutes a valid attribute, measurements against validity rules, attribute, record and lineage schemas, apportionment data for how much of each job role or business unit is affected by quality issues; determining one or more attribute movements of the attribute movements related to the measurement and rules based on the received data; and identifying relevant costs associated with the determined one or more attribute movements. The method may also include apportioning the business costs that are caused by quality issue to determine: per-attribute and per-record valuations of all movement valuations that can be apportioned to quality; and per-quality rule valuations of the attribute movements that contributed to the rule and failure of the rule.

In an example, the data including the rules what constitutes or defines a valid attribute, measurements against validity rules, attribute, record and lineage schemas, apportionment data for how much of each job role or business unit is affected by quality issues may be received by using at least one of surveys and stakeholder analysis from the one or more key business process nodes.

In some embodiments, the analytical system is configured to valuate costs involved in moving attributes or information within an organisation based on financial data from GL, stakeholder engagement etc. and by expense-lineage mapping. Such data may be received or loaded into the system via at least one of batch, micro batch, real-time, manual, data entry or by using other suitable method. In such embodiments, the analytical system (or tool) may include network and system interfaces, a financial system interpreter module, an apportionment module, an attribute content analyser module, an analysis module, a reporting module, a scheduling module, an audit/reconciliation module, and a management module. In some embodiments, at least one of the financial statement interpreter module, the apportionment module, and the attribute contribute analyser, and the analysis module may be configured for valuation of each of the attribute movements based on financial data from the GL or other financial systems or sources. Further, at least one of the reporting module, the scheduling module, the audit/reconciliation module, and the management module may be configured for reconciling financial information back to financial system information and other analytical roll up to business unit and job role. Further, the analytical system may include a memory, a storage module, and a processing module configured to store and process the analytical information.

In some embodiments, the analytical system is configured to perform attribute movement valuation based on transactions' data from the general ledger. The data comprising the transactions' data, attribute movement valuation data, record and table schemas, other metadata, and scheduler information may be received or loaded into the system via at least one of batch, micro batch, real-time, manual, data entry or by using other suitable method. In such embodiments, the system includes the network and system interfaces, a financial statement interpreter module, a schema mapper module, a lineage parser module, an analysis module, a reporting module, a scheduling module, an audit/reconciliation module, and a management module. In some embodiments, at least one of the financial statement interpreter module, the schema mapper module, the lineage parser module, and the analysis module may be configured for valuation of movements that established the record based on attribute movement valuation, record and table schemas, or other metadata. Further, at least one of the reporting module, the scheduling module, audit/reconciliation module, and management module may be configured for aggregation of all attribute movements through to creation based on the schedular information. Further, the analytical system includes the memory, the storage module, and the processing module configured to store and process the analytical information.

In some embodiments, the schema mapper module may map information and may be configured to record and table schemas.

In some embodiments, the lineage parser module may be configured for expense-lineage mapping based on metadata for attributes, rows and lineages.

In some embodiments, the attribute content analyser may be configured for attribute movement valuation and may validate attribute movements based on attribute movement information from metadata systems, and frequency of attribute movement from schedulers or otherwise.

In some embodiments, the financial statement interpreter may be configured for extracting financial information from the general ledger or other financial sources. Further, the financial interpreter may validate and interpret financial information.

In some embodiments, the scheduling module (also referred as schedular) may store information or log about the frequency of attribute movements or other scheduler information.

In some embodiments, the analysis module may be configured to determine frequency of the record and time period the record belong to. Further, the analysis module may identify immediate movements of attributed that went into this record. Further, the analysis module may determine identify all upstream movements of attributed right back to attribute creation.

In some embodiments, the audit/reconciliation module may aggregate movement valuations for the record. Further, the audit/reconciliation module may aggregate all attribute movements through to creation. The audit/reconciliation module may also determine per-record level valuations consisting of the movements that established the record.

In some embodiments, the analytical system is configured to valuate or determine costs based on quality of data or attributes or costs for quality lost during movements of data within an organisation. The data or attributes may be loaded in the analytical system via batch, micro batch, real-time, manual, data entry or using any other suitable method. In such embodiments, the analytical system (or tool) may include network and system interfaces, a quality interpreter module, an apportionment module, a lineage parsing module, an analysis module, a reporting module, a scheduling module, an audit/reconciliation module, and a management module. In some embodiments, at least one of the quality interpreter module, the apportionment module, and lineage parsing module may be configured for apportionment of quality on attribute movements based on business rules for attributed, records and table schemas. Further, at least one of the analysis module, the reporting module, the scheduling module, the audit/reconciliation module, and the management module may be configured for determining aggregated per-attribute quality costs based on quality measurement data, and apportionment data. Further, the analytical system includes the memory, the storage module, and the processing module configured to store and process the analytical information.

In some embodiments, the analytical system is configured to measure an amount of effort or cost lost due to poor/low-quality data. Further, in some embodiments, the analytical system is configured to determine a cost or value of effort required for enhancing the quality of poor/low-quality data.

In some embodiments, the analytical system is configured to perform data quality apportionment and interpret the data quality. Further, the system is configured to identify expenses most affected by the data quality (or poor or low data quality) and take cleanse or remediation action. In some embodiments, the analytical system can identify waste areas and take process actions accordingly. Further, the system can prepare necessary reports.

In some embodiments, the analysis module is configured to determine per-record level valuations consisting of all upstream movements that established the record.

The analytical tools/systems and methods of the present disclosure are configured to determine what costs are applicable to the movement of data as well as costs lost to quality.

Further, the system of this present disclosure (or invention) integrates or interfaces with finance systems to calculate annual costs in moving the data.

Further, the system and method of this present disclosure are configured to value movement of data between points of rest.

The system and method of this present disclosure focuses on valuing a movement of data and apportioning all organisational costs it.

In some embodiments, the analytical system is configured to identify expensive areas to target. For example, the expensive areas may include data movements or nodes that moved data of low quality that in turn increased cost as cleansing of the low-quality data may be required. Further, the system may identify a type of waste for the identified expensive areas. Accordingly, for these expensive areas that may include expensive processes or expensive data or data movements, remedial actions may be identified and costs involved with the remedial actions may be determined by the system. Furthermore, the system may be configured to measure or monitor an impact of the quality enhanced data or changed processes.

The system and method of this present disclosure may use an Apportionment Based Costed Data (ABCD) model or method to determine how much it costs to capture, move and analyse data. Further, this approach (model or method) may best suit to services companies that are organized around information workers. The method to capture this detail may involve the following steps: extracting operational expenses (OPEX) from the GL that have not already been mapped as a Direct Expense to a product or service; Mapping flows at a high level with architects and a low level with automated lineage tools, wherein the data is profiled to understand volumes and complexities through this process; mapping key business process for data capture and reference data; and apportioning identified costs to the applicable flow. In some embodiments, the method may also include measuring data quality and map to the ABCD model.

The system and method of this present disclosure are implemented to provide the outcome of quantifying the effect on the organisation's “bottom line”.

The analytical system of the present disclosure is configured to values only movements of data between rest states.

In some embodiments, the disclosed analytical systems and methods determines what costs are applicable to the movement of data as well as costs lost to quality. Further, the systems and methods disclosed herein integrates with the finance systems of an organisation to calculate the annual costs in moving the data. The systems and methods focuses on valuing the movement of data and apportioning all organisation's costs of movement of data. The systems and methods values data between point of rests (or data point or nodes).

An embodiment of the present disclosure provides analytical tool operable to quantify information flow within an information network having nodes and flow paths between pairs of said nodes. The analytical tool

[symbol]

The present disclosure also provides a non-transitory computer readable storage medium determining a cost for capturing, moving, and analysing data, when executed by a computing device cause the computing device to: extract financial data comprising operational expenses (OPEX) from a financial data source comprising a general ledger (GL) that have not already been mapped as a direct expense to at least one of a product or a service; map a plurality of data flows at a high level with architects and at a low level with automated lineage tools by profiling the data to understand volumes and complexity of the data; map one or more key business process nodes for data capture and reference data for identifying costs from the captured data; and apportion identified costs from the one or more key business process nodes to an applicable data flow of the plurality of data flows.

According to another aspect of the present disclosure, there is provided a computer-driven analysis delivery platform having a layered architecture structured for delivering cost-related network elements of an organisational object under scrutiny. The computer-driven analysis delivery platform includes an interaction layer comprising a plurality of nodes that operatively interact with a workflow layer; a workflow layer being configured to receive inputs from devices operated by device users, each user device being associated with at least one designated node and configured for collecting information; and a data layer comprising database-generating means, operably programmed to capture from the user devices networked elements of the object under scrutiny.

In some embodiments, the computer-driven analysis delivery platform further includes an authoring layer operable to customise the platform, wherein the authoring layer comprises an authoring tool.

These embodiments merely illustrate a particular example of the method, and platform of the present disclosure providing means for determining the monetary value of data in an organisation. It will be appreciated by those skilled in the art having the benefit of this disclosure that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to or discernible by those of ordinary skill in the art, without departing from the spirit and scope hereof, as defined by the following claims. Thus, it is intended that the claims following hereon be interpreted to embrace all such further modifications, changes, rearrangements, substitutions, alternatives, design choices, and embodiments.

With the insight gained from this disclosure, the person skilled in the art is well placed to discern further embodiments by means of which to put the claimed present disclosure into practice.

1.-7. (canceled)

8. A method of setting a value on data movement within an enterprise network comprising a plurality of operating nodes, between which information flows, the method comprising:
developing a cost driver model in which individual internodal flows of said information are identified, and implementing the model with respect to each of said flows, the model requiring apportionment of costs accumulated in operating the nodes between the individually identified flows.

9. The method according to claim 8 wherein the developing the cost driver model further comprises documenting for each business node the information flows to, from and within it.

10. The method according to claim 8 further comprising:
identifying an outcome for each flow of the identified flows.
identifying an activity driver for each flow of the identified flows;
generating a data flow map showing flow volumes between the plurality of operating nodes;
determining a cost associated with moving data from a first node to a second node of the plurality of operating nodes; and
identifying one or more areas for cost improvement in the organisation.

11. The method according to the claim 8 further comprising setting an information cost target and applying analytics to an information channel relating to the target in a manner effective to reach the target.

12. The method according to claim 8 further comprising determining an impact of data quality on network operating cost in a manner to prioritise data cleansing.

13. The method according to the claim 8 further comprising taking a lineage-based view of the information flows.

14. The method of claim 8 further comprising applying the following formula to the information flows identified:
$$Cost of a Flow = {\sum }_{i = 0}^{n} [ {( \begin{matrix}{Expendiure}_{i} * DQFactor * \\ \frac{UnitsAllocated}{{TotalUnitsForExpenditure}_{i}}\end{matrix} )}_{DQCost} + {( \begin{matrix}{Expendiure}_{i} * ( 1 - DQFactor ) * \\ \frac{UnitsAllocated}{{TotalUnitsForExpenditure}_{i}}\end{matrix} )}_{NonDQCost} ]$$
Where:
Each expenditure “i” of all expenditures “n” is apportioned to the information flow (using a general ledger code or similar as a key)
“Expenditure” is the total value of the expenditure for the period under assessment
“DQFactor” is the percentage of an individual flow under consideration and expenditure that has been caused by poor data quality
“UnitsAllocated” divided by “TotalUnitsForExpenditure” represents a portion of the individual expense concerned to be allocated to said information flow

15.-16. (canceled)

17. A method for determining a cost for capturing, moving, and analysing data by using an analytical system, comprising:
extracting financial data comprising operational expenses (OPEX) from a financial data source comprising a general ledger (GL) that have not already been mapped as a direct expense to at least one of a product or a service;
mapping a plurality of data flows at a high level with architects and at a low level with automated lineage tools by profiling the data to understand volumes and complexity of the data;
mapping one or more key business process nodes for data capture and reference data for identifying costs from the captured data; and
apportioning identified costs from the one or more key business process nodes to an applicable data flow of the plurality of data flows.

18. The method according to claim 17 further comprising:
measuring data quality by at least one of reconciling information by reconciling data sent from one node of the one or more key business process nodes and received by another node of the one or more key business process nodes to determine a network of internodal data flow paths and performing one or more data quality checks;
mapping the data to the plurality of data flows; and
tracking one or more costs associated with the network by extracting costs data pertaining to each node from the general ledger from an accounting system.

19. The method according to claim 17 further comprising:
receiving financial information or data comprising the extracted OPEX data from the GL and information from other financial data sources, attribute movement information from metadata systems or other key business process nodes, frequency of attribute movement from schedulers, job role and business unit information from the one or more key business process nodes comprising enterprise systems, and stakeholder engagement, apportionment of attribute movements to job role and business unit from the one or more key business process nodes;
validating and interpreting financial information/data;
validating attribute movements based on at least one of the attribute movement information, and the frequency of attribute movement;
attributing job role, business unit or other financial information to each attribute movements of the validated attribute movements based on the received job role and business unit information and the apportionment of attribute movements to job role and business unit from the one or more key business process nodes;
reconciling financial information that has been fully attributed onto attribute movements; and
preparing information comprising pre-attribute movement values for every attribute movements, reconciliation back to financial system information, and analytical roll up to business unit and job role information for business use.

20. The method according to claim 17 further comprising:
receiving attribute movement valuations for all movements, record and table schemas, other metadata for attributes, rows, and lineages, and schedule information, from the one or more key business process nodes;
determining a frequency of record and time period related to the record based on at least one of the record and table schemas, other metadata for attributes, rows, and lineages, and schedule information;
identifying immediate movements of attributed that went into the record;
identifying all upstream movements of attributed right back to attribute creation; and
aggregating the attribute movement valuations for the record to determine:
per-record level valuations comprising the movements that established the record; and
per-record level valuations consisting of all upstream movements that established the record.

21. The method according to claim 17 further comprising:
receiving data comprising rules for what constitutes a valid attribute, measurements against validity rules, attribute, record and lineage schemas, apportionment data for how much of each job role or business unit is affected by quality issues;
determining one or more attribute movements of the attribute movements related to the measurement and rules based on the received data;
identifying relevant costs associated with the determined one or more attribute movements; and
apportioning the business costs that are caused by quality issue to determine:
per-attribute and per-record valuations of all movement valuations that can be apportioned to quality; and
per-quality rule valuations of the attribute movements that contributed to the rule and failure of the rule.

22. The method according to claim 17 further comprising:
identifying expensive areas and processes to target;
for the identified processes:
prioritising work by business process management teams for expensive captured processes;
restructuring underperforming information areas;
identifying expensive decision-making process and developing decision models; and
identifying opportunities to utilise automation tools.

23. The method of claim 18 further comprising:
enhancing data quality of captured data by:
actioning a plan to cleanse poor-quality data; and actioning a plan to remediate root causes for the poor-quality data;
changing the captured processed to enhance the data quality; and
measuring and monitoring an impact.

24.-26. (canceled)
